(19) United States
(12) Patent Application Publication
(10) Pub. No.: US 2016/0182951 A1
(43) Pub. Date: Jun. 23, 2016

(54) AUTOMATIC "RETURN TO PROGRAM" FEATURE FOR A VIDEO DELIVERY SYSTEM

(71) Applicant: SLING MEDIA PVT LTD, Bangalore (IN)

(72) Inventors: Roj Thomas, Bangalore (IN); Ajay L. Davanam, Bangalore (IN)

(21) Appl. No.: 14/580,561

(22) Filed: Dec. 23, 2014

(51) Int. Cl. H04N 21/45; H04N 21/466; H04N 21/6587

(52) U.S. Cl. CPC H04N 21/4532; H04N 21/6587; H04N 21/466

(57) ABSTRACT

An embodiment of a method of managing delivery of video content determines, with a video presentation system, that a first video event currently provided on a first video service is preferred by a user of the system. The method continues by detecting a channel switching action that occurs in association with presentation of interstitial video content corresponding to the first video event on the first video service, and by providing a second video event on a second video service for presentation to the user. The method continues by detecting, with the system, completion of the interstitial video content on the first video service. In response to detecting completion of the interstitial video content on the first video service, an automatic channel switching action is performed to switch from the second video service to the first video service to resume presentation of the first video event to the user.

### TECHNICAL FIELD

Embodiments of the subject matter described herein relate generally to video services receivers. More particularly, embodiments of the subject matter relate to certain operating methodologies that automatically return a video services receiver to a preferred channel after the completion of a commercial break that appears between program segments.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Network video programming usually includes commercial breaks and/or other forms of interstitial video content interspersed between segments of program content. Many viewers switch channels at or near the beginning of a commercial break, intending to return to the original channel at or near the end of the commercial break. There may be times, however, when a viewer forgets to return to the original channel. In other situations, the user might switch channels back and forth (channel surfing) to ensure that none of the program content on the original channel is missed.

Accordingly, it is desirable to have a methodology for determining when a commercial break in a preferred or designated video event is at or near completion, and for automatically returning to that video event (when the user has changed channels during the commercial break). Furthermore, other desirable features and characteristics will become apparent from the subsequent detailed description and the appended claims, taken in conjunction with the accompanying drawings and the foregoing technical field and background.

### BRIEF SUMMARY

A method of managing delivery of video content is presented. An exemplary embodiment of the method determines, with a video presentation system, that a first video event currently provided on a first video service is preferred by a user of the video presentation system. The method detects a channel switching action that occurs in association with presentation of interstitial video content corresponding to the first video event on the first video service, and provides a second video event on a second video service for presentation to the user, wherein the providing is performed after detecting the channel switching action. The method continues by detecting, with the video presentation system, completion of the interstitial video content on the first video service. In response to detecting completion of the interstitial video content on the first video service, the method automatically switches from the second video service to the first video service to resume presentation of the first video event to the user.

Also presented is an embodiment of a video presentation system having a receiver interface, a display interface, and a processor. The receiver interface receives data associated with video services, including a first video event on a first video service and a second video event on a second video service. The display interface is operatively coupled to the video services receiver to facilitate presentation of video content on a display. The processor designates the first video event on the first video service as a user-preferred video event, detects a channel switching action that occurs in association with presentation of interstitial video content corresponding to the first video event, provides the second video event for presentation to a user in response to detecting the channel switching action, detects completion of the interstitial video content on the first video service, and automatically switches from the second video service to the first video service in response to detecting completion of the interstitial video content, such that presentation of the first video event to the user is resumed.

Another embodiment of a method of managing delivery of video content is also presented. The method begins by presenting a first video event having interstitial video content that transitions to a segment of video content. The method continues by detecting a switching action that occurs during presentation of the interstitial video content, wherein the switching action terminates presentation of the first video event and initiates presentation of a second video event. While the second video event is being presented, a transition from the interstitial video content to the segment of video content is detected. In response to detecting the transition, the method automatically switches from the second video event to the first video event to initiate presentation of the segment of video content.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a video delivery system;

FIG. 2 is a block diagram that illustrates an exemplary embodiment of a video place-shifting system, which may be utilized in the video delivery system shown in FIG. 1;

FIG. 3 is a flow chart that illustrates an exemplary embodiment of a process for managing delivery of video content;

FIG. 4 is a diagram that illustrates an automatic return-to-channel operation; and

FIG. 5 is a diagram that illustrates a notification feature associated with an automatic return-to-channel operation.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content conveyed in a video stream, the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based content delivery system, a cellular network delivery system, or the like. The disclosed subject matter relates to a system and related methodology for automatically changing channels from a secondary channel to a preferred, designated, or original channel. The return-to-channel (RtC) feature can be utilized when a user navigates from an original video event on a first video service to a different video event on a second video service during a commercial break, such that the user does not miss much (if any) of the original program content following the commercial break. Thus, the viewer need not prematurely switch back to the first channel to monitor the status of the commercial break. Instead, the viewer can enjoy a different video program on a different channel until the system automatically detects the end of the commercial break and returns to the first channel.

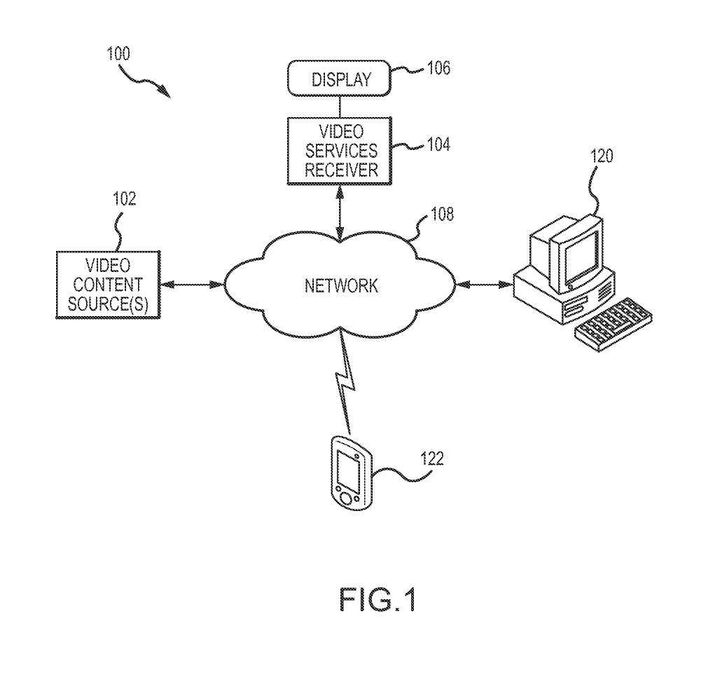

FIG. 1 is a block diagram that illustrates an exemplary embodiment of a video delivery system 100 that is suitably configured to support the techniques and methodologies described in more detail below. The system 100 (which has been simplified for purposes of illustration) generally includes, without limitation: at least one video content source 102 (referred to in the singular form herein for the sake of convenience); a video services receiver 104 or other form of customer equipment that is capable of receiving, processing, and rendering video content; and a display 106 operatively coupled to the video services receiver 104. In certain embodiments, the video content source 102 communicates with the video services receiver 104 using a data communication network 108. For the sake of brevity, conventional techniques related to satellite, cable, and Internet-based communication systems, video broadcasting systems, data transmission, signaling, network control, and other functional aspects of the systems (and the individual operating components of the systems) may not be described in detail herein.

The data communication network 108 is any digital or other communications network capable of transmitting messages between senders (e.g., the video content source 102) and receivers (e.g., the video services receiver 104). In various embodiments, the network 108 includes any number of public or private data connections, links or networks supporting any number of communications protocols. The network 108 may include the Internet, for example, or any other network based upon TCP/IP or other conventional protocols. In various embodiments, the network 108 also incorporates a wireless and/or wired telephone network, such as a cellular communications network for communicating with mobile phones, personal digital assistants, and/or the like. The network 108 may also incorporate any sort of wireless or wired local area networks, such as one or more IEEE 802.3 and/or IEEE 802.11 networks.

The video content source 102 may be deployed as a head end facility and/or a satellite uplink facility for the system 100. In some embodiments, the video content source 102 may include or cooperate with one or more web-based content delivery applications, services, or providers. The video content source 102 generally functions to control content, signaling data, programming information, and other data sent to any number of receiving components. In practice, the video content source 102 also provides content and data that can be used to populate an interactive electronic program guide (EPG) generated by the video services receiver 104.

The video content source 102 includes one or more data processing systems or architectures that are capable of producing signals that are transmitted to customer premise equipment, mobile devices, computer systems, or the like. In various embodiments, the video content source 102 represents a satellite, cable, or other content distribution center having: a data control system for controlling content, signaling information, blackout information, programming information, and other data; and an control system for transmitting content, signaling information, blackout information, programming information, and other data using high-bandwidth links. These systems may be geographically, physically and/or logically arranged in any manner, with data control and uplink control being combined or separated as desired.

The video services receiver 104 can be realized as any device, system or logic capable of receiving signals from the video content source 102. Accordingly, the video services receiver 104 may include a receiver interface to receive data associated with video services, including any number of video events that are provided by various video providers. The video services receiver 104 is capable of providing demodulated content to a customer via the display 106. Accordingly, the video services receiver 104 may include a suitable display interface for the display 106, where the display interface facilitates presentation of video and image content on the display 106. As explained in more detail below, the video services receiver 104 may also be configured to generate a suitably formatted program return notification for rendering on the display 106 at appropriate times, and to respond in an appropriate manner if the user interacts with the program return notification.

The display 106 may be realized as any of the following, without limitation: a television set; a monitor; a computer display; or any suitable customer appliance with compatible display capabilities. In various embodiments, the video services receiver 104 is implemented as a set-top box (STB) as commonly used with digital video broadcasting, satellite, or cable television distribution systems. In other embodiments, however, the functionality of the video services receiver 104 may be commonly housed within the display 106 itself In still other embodiments, the video services receiver 104 is a portable device that may be transportable with or without the display 106. The video services receiver 104 may also be suitably configured to support broadcast television reception, video game playing, personal video recording and/or other features as desired.

During typical operation, the video services receiver 104 receives programming (broadcast events, on-demand video events, emergency broadcasts, etc.), signaling information, and/or other data via the network 108. The video services receiver 104 then demodulates, decompresses, descrambles, and/or otherwise processes the received digital data, and then converts the received data to suitably formatted video signals that can be rendered for viewing by the customer on the display 106. The video services receiver 104 may also be capable of receiving web-based content via the network 108, the Internet, etc., and may also be capable of recording and playing back video content.

The video services receiver 104 can be operated in a traditional manner to receive, decode, and present a current video stream for presentation to a user (i.e., content provided by a given video service or channel). Moreover, the video services receiver 104 can be operated to identify interstitial video content that is interspersed with the desired video program content, wherein the interstitial content may include advertisements, commercials, and/or other forms of secondary content. In certain implementations, the video services receiver 104 includes multiple tuners to enable it to concurrently receive and process one video stream for rendering and presentation while receiving and processing one or more additional video streams in the background if needed.

A video stream is usually associated with a particular video service (or channel). When the video services receiver 104 is tuned to a given video service, the rendered video stream conveys video program content, e.g., video program events, interstitial video content, marketing content, emergency broadcasts, and the like. As used here, a “video event” is akin to a program or a show. Thus, in accordance with traditional network broadcast programming schemes, a single video event may include one or more program segments (i.e., the actual content of the show) and one or more segments of interstitial video content interspersed with the desired program segments. For example, a thirty minute time slot may include several commercial breaks between consecutive segments of video program content. In accordance with ordinary practice, if the video services receiver 104 remains tuned to the same channel for a long period of time, then it will receive and render different video events in sequence, along with any associated interstitial video content.

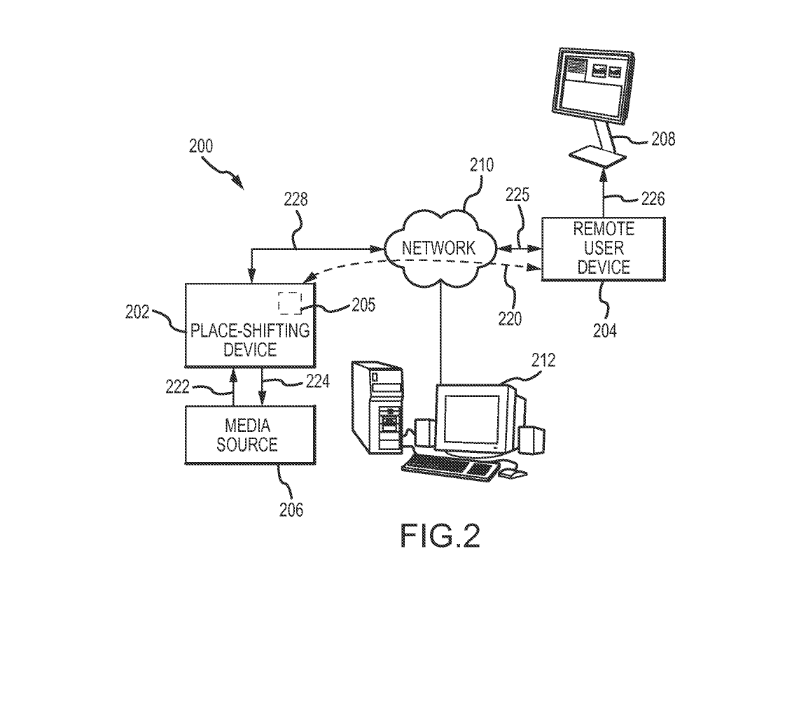

Although not separately depicted in FIG. 1, the video services receiver 104, the source of video content 102, and/or another component in the system 100 may include video place-shifting functionality, or it may cooperate with a suitably configured place-shifting device or component to place-shift video content. In this regard, it may be possible to provide live or recorded content to a remote device operated by the user, wherein the video services receiver 104, the source of video content 102, and/or another component in the system 100 serves as a source of the place-shifted content. Place-shifting functionality is described in more detail below with reference to FIG. 2.

Although not required, the system 100 may support additional video presentation devices that enable the viewer to enjoy video programming at different locations. In this regard, the video services receiver 104 may be considered to be a primary video delivery device, especially if it is realized as a conventional STB that is connected to a monitor or television set in the user's home. The user may also own or operate a computing device 120 that is configured to receive and present video content. The user may also own or operate a mobile device 122 that is configured to receive and present video content. The computing device 120 may be realized using any compatible platform, including, without limitation: a desktop computer; a laptop computer; a tablet computer; a smart television device; a video game console; or any suitably configured piece of electronic equipment. The mobile device 122 may be realized using any compatible platform, including, without limitation: a smartphone; a digital media player; a handheld navigation device; a portable medical device; a smart wristwatch or other wearable computing device; or the like.

The video services receiver 104, the computing device 120, and the mobile device 122 (along with any other video presentation device that supports the methodology described herein) can be implemented as (or can be integrated with) an electronic processor-based component. Regardless of its form factor and hardware platform, a video presentation device or system as described herein is suitably configured to support the desired features and functions using the appropriate hardware, software, firmware, etc. For example, the video services receiver 104 may include, without limitation: an input module or interface to receive video streams from the video content source 102; a network communication module to interface with the data communication network 108; device-specific hardware, software, firmware, and/or applications; at least one processor; and at least one memory element having a suitable amount of storage capacity. These elements cooperate to perform the various processes and methods described in more detail below.

In accordance with some embodiments of the system 100, the user can instruct the system 100 to “move” video content from one presentation device to another. Any suitable mechanism could be employed to move video content from one device to another. In this regard, FIG. 2 is a block diagram that illustrates an exemplary embodiment of a video place-shifting system 200, which may be utilized in the video delivery system 100 shown in FIG. 1. The system 200 can be utilized to carry out place-shifting and other processing of video content. Certain embodiments of the system 200 include a digital media processing device (e.g., a digital media place-shifting device 202) that receives a video stream 222 from a media source 206, encodes the received video stream 222 into a streaming format, and then transmits the encoded video stream 220 to a remotely-located digital media player or other presentation device over a data communication network 210. The presentation device is referred to herein as a remote user device 204. The remote user device 204 receives the encoded video stream 220, decodes the stream, and presents the decoded content to a viewer on a television or other display 208. Although not depicted in FIG. 2, the remote user device 204 includes or cooperates with at least one speaker, audio transducer, or other sound-generating element that supports the presentation of the audio portion of media streams. In various embodiments, a centralized mediation server device 212 may also be provided to communicate with the place-shifting device 202 and/or the remote user device 204 via the network 210 to assist these devices in locating each other, maintaining security, providing or receiving content or information, and/or any other features as desired.

The place-shifting device 202 is any component, hardware, software logic, etc., or any combination thereof, which is capable of transmitting a packetized stream of media content over the network 210. For example, the place-shifting device 202 may be a physically distinct component that is operatively coupled to a video services receiver (a set-top box) that serves as the media source 206. As another example, the place-shifting device 202 may be integrated with a video services receiver. In various embodiments, the place-shifting device 202 incorporates suitable encoder and/or transcoder (collectively “encoder”) logic to convert audio/video or other media content (e.g., the video stream 222) into a packetized format that can be transmitted over the network 210. The video stream 222 may be received in any format, and may be received from any internal or external media source 206 such as any sort of broadcast source, a cable or satellite television programming source, a “video-on-demand” or similar source, a digital video disk (DVD) or other removable media, a video camera, and/or the like. In some operating scenarios, a video stream received and processed by the place-shifting device 202 is a recorded video stream, which may be provided by the media source 206, by a digital video recorder module, by a video services receiver coupled to the place-shifting device 202, or the like. In this context, the recorded video stream could be realized as a locally recorded file, or it could be realized as an on-demand video stream. In some operating scenarios, a video stream received and processed by the place-shifting device 202 is a non-recorded broadcast video stream, which is currently being delivered by a video services system. The place-shifting device 202 encodes the video stream 222 to create the encoded video stream 220 in any manner. In various embodiments, the place-shifting device 202 contains a transmit buffer 205 that temporarily stores encoded data prior to transmission on the network 210.

In practice, an embodiment of the place-shifting device 202 may be implemented using any of the various SLINGBOX products available from Sling Media of Foster City, Calif., although other products could be used in other embodiments. Certain embodiments of the place-shifting device 202 are generally capable of receiving the video stream 222 from an external media source 206 such as any sort of digital video recorder (DVR), set top box (STB), cable or satellite programming source, DVD player, and/or the like. In such embodiments, the place-shifting device 202 may additionally provide commands 224 to the media source 206 to produce the desired video stream 222. Such commands 224 may be provided over any sort of wired or wireless interface, such as an infrared or other wireless transmitter that emulates remote control commands receivable by the media source 206. Other embodiments, however, may modify or omit this feature entirely.

In other embodiments, the functionality of the place-shifting device 202 may be integrated with any sort of content-receiving or other capabilities typically affiliated with the media source 206. Accordingly, the place-shifting device 202 may be a hybrid STB or other receiver, for example, that also provides transcoding and place-shifting features. Such a device may receive satellite, cable, broadcast and/or other signals that encode television programming or other content received from an antenna, modem, server and/or other source. A receiver of the place-shifting device 202 may further demodulate or otherwise decode the received signals to extract programming that can be locally viewed and/or place-shifted to the remote user device 204 as appropriate. In this regard, the place-shifting device 202 may also include a content database stored on a hard disk drive, memory, or other storage medium to support a personal or digital video recorder (DVR) feature or other content library as appropriate. Hence, in some embodiments, the media source 206 and the place-shifting device 202 may be physically and/or logically contained within a common component, housing or chassis.

In still other embodiments, the place-shifting device 202 includes or is implemented as a software program, applet, or the like executing on a conventional computing system (e.g., a personal computer). In such embodiments, the place-shifting device 202 may encode, for example, some or all of a screen display typically provided to a user of the computing system for place-shifting to a remote location. One device capable of providing such functionality is the SlingProjector product available from Sling Media of Foster City, Calif., which executes on a conventional personal computer, although other products could be used as well.

The remote user device 204 is any device, component, module, hardware, software, etc., or any combination thereof, which is capable of receiving the encoded video stream 220 from one or more place-shifting devices 202. In various embodiments, the remote user device 204 is personal computer (e.g., a laptop or similarly portable computer, although desktop-type computers could also be used), a mobile phone, a personal digital assistant, a personal media player, or the like. In many embodiments, the remote user device 204 is a general purpose computing device that includes a media player application in software or firmware that is capable of securely connecting to the place-shifting device 202, and is capable of receiving and presenting media content to the user of the device as appropriate. In other embodiments, however, the remote user device 204 is a standalone or other separate hardware device capable of receiving the encoded video stream 220 via any portion of the network 210 and decoding the encoded video stream 220 to provide an output signal 226 that is presented on the display 208. One example of a standalone remote user device 204 is the SLINGCATCHER product available from Sling Media of Foster City, Calif., although other products could be equivalently used.

The place-shifting device 202 and/or the remote user device 204 are therefore able to communicate in any manner with the network 210 (e.g., using any sort of data communication links 228 and/or 225, respectively). Such data communication may take place over a wide area link that includes the Internet and/or a telephone network, for example; in other embodiments, communications between the place-shifting device 202 and the remote user device 204 may take place over one or more wired or wireless local area links that are conceptually incorporated within the network 210. In various equivalent embodiments, the place-shifting device 202 and the remote user device 204 may be directly connected via any sort of cable (e.g., an Ethernet cable or the like) with little or no other network functionality provided.

Many different place-shifting scenarios could be formulated based upon available computing and communications resources, consumer demand and/or any other factors. In various embodiments, consumers may wish to place-shift content within a home, office or other structure, such as from the place-shifting device 202 to a desktop or portable computer located in another room. In such embodiments, the content stream will typically be provided over a wired or wireless local area network operating within the structure. In other embodiments, consumers may wish to place-shift content over a broadband or similar network connection from a primary location to a computer or other remote user device 204 located in a second home, office, hotel or other remote location. In still other embodiments, consumers may wish to place-shift content to a mobile phone, personal digital assistant, media player, video game player, automotive or other vehicle media player, and/or other device via a mobile link (e.g., a GSM/EDGE or CDMA/EVDO connection, any sort of 3G or subsequent telephone link, an IEEE 802.11 “Wi-Fi” link, and/or the like). Several examples of place-shifting applications available for various platforms are provided by Sling Media of Foster City, Calif., although the concepts described herein could be used in conjunction with products and services available from any source.

The system 100 includes an automatic RtC feature, which can be activated, disabled, or otherwise configured by the user. When enabled and active, the RtC feature automatically and autonomously controls the video presentation system (e.g., a set-top box) to switch channels back to a preferred or otherwise designated original channel in a situation where the user changes channels during a commercial break. In accordance with some exemplary embodiments, the RtC function is performed seamlessly and transparently with no user involvement or action. In accordance with other exemplary embodiments, the RtC function also involves the generation and display of a suitably formatted user notification, which is rendered concurrently with the current video content and provides the user with an opportunity to take certain actions (e.g., switch back to the original video event, record the original video event, place-shift the original video event, or the like).

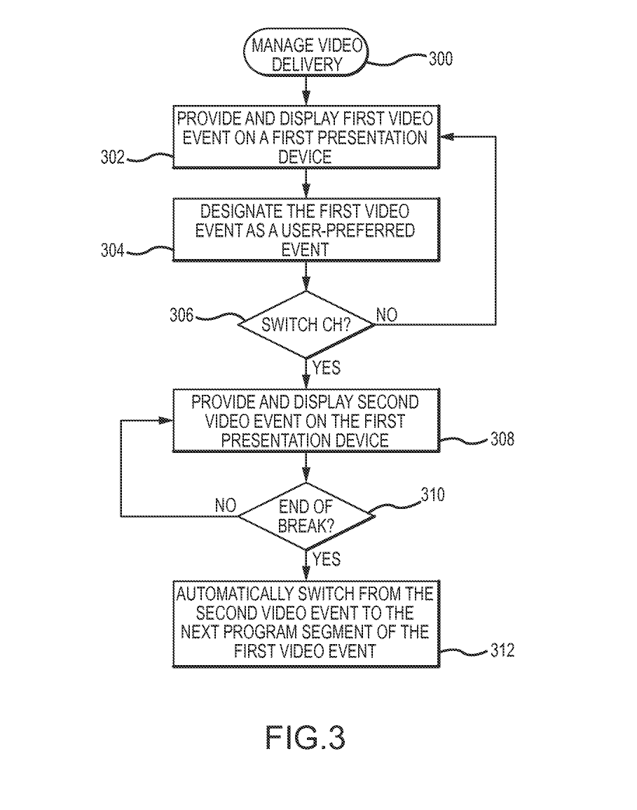

FIG. 3 is a flow chart that illustrates an exemplary embodiment of a process 300 for managing delivery of video content. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., a video content source or server, a video services receiver, a place-shifting device, a presentation device, etc. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 can be executed during the presentation and display of video content. In this regard, the process 300 provides a first video event for presentation (display) on a first presentation device (task 302). For purposes of this description, assume that the first video event corresponds to a program being broadcast on Channel 8, and that the first presentation device is a display (television) coupled to a video services receiver. Although this description assumes that the first video event represents non-recorded content, the techniques and methodologies presented here could also be utilized to manage and process recorded content, such as on-demand video content or video content that has been locally stored at the customer premise. The techniques and methodologies described here may also be utilized to manage and process streaming video content if so desired.

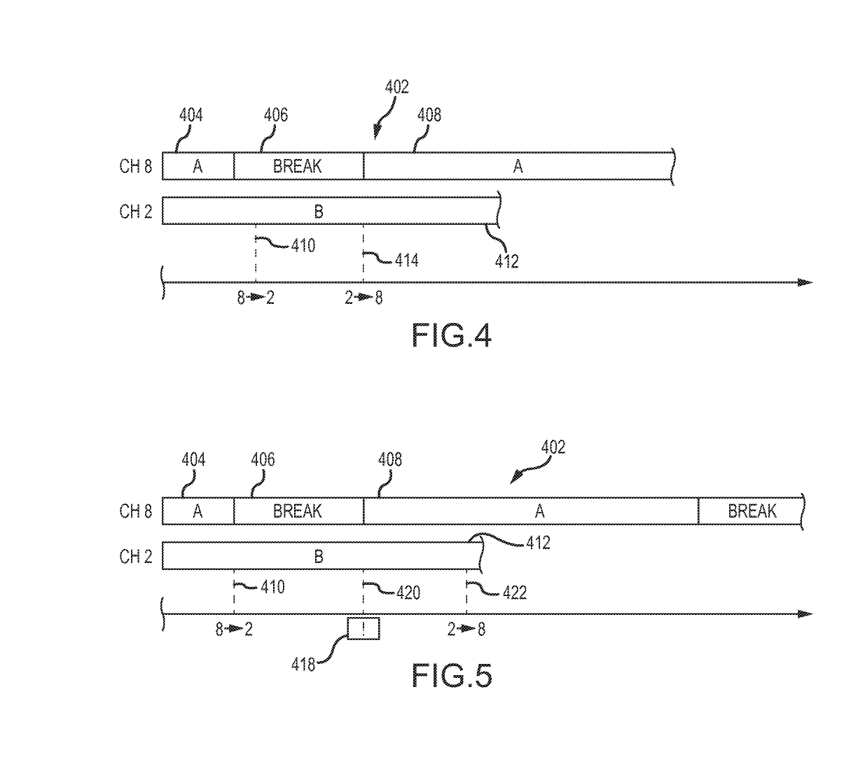

Task 302 is performed to render and present the first video event to one or more users. For this example, the first video event includes at least one segment of interstitial content that transitions to a segment of video program content. As mentioned above, a typical broadcast video event includes a plurality of video program segments having one or more intervening segments of interstitial content (e.g., commercial breaks). Thus, a given segment of interstitial video content may include a commercial break that is located between two program segments of a video event. In this regard, FIG. 4 is a diagram of an automatic RtC operation that is consistent with the example presented here. FIG. 4 depicts the first video event 402 horizontally along a time axis; the first video event 402 corresponds to Channel 8. The first video event 402 includes a leading program segment 404 of the video content, a segment of interstitial video content 406, and a trailing program segment 408 of the video content. The actual video program content on Channel 8 is identified by the letter “A” in the leading program segment 404 and the trailing program segment 408.

Referring again to FIG. 3, the process 300 designates the first video event as a user-preferred video event (task 304) or otherwise determines that the first video event is preferred by a user of the video presentation system. Task 304 is desirable to ensure that the system only activates the RtC feature at appropriate times. For example, task 304 may involve the video presentation system receiving a user-initiated command or instruction to specifically designate a video event as a preferred video event. In some situations, the user-initiated command is received during the presentation of a program segment of the video event of interest. In other scenarios, the user-initiated command is received during presentation of interstitial video content that appears before, after, or between program segments of the video event of interest. This allows the viewer to actively decide whether or not to utilize the RtC feature by flagging his or her preferred video content. In certain embodiments, the user-initiated command is generated in response to user activation of a special “Back to Program” button (or an equivalent button or sequence of buttons) of a remote control device that wirelessly controls the operation of the host video presentation system.

Alternatively or additionally, task 304 may employ some intelligent processing or analysis performed by the video presentation system. For example, task 304 may involve the monitoring of a continuous viewing time period during which the video event of interest is presented to the user. If the continuous viewing time period exceeds a threshold time period (e.g., five or ten minutes), then the process 300 designates that video event as a preferred video event for purposes of the RtC feature. As another example, the system can monitor the user's channel surfing habits to determine whether the user has returned to the video event after previous commercial breaks and, if so, designate the video event as a user-preferred event. As yet another example, if the system detects that the user has remained on the same channel throughout one or more commercial breaks, then it can assume that the user is interested in the program content on that channel and, therefore, flag the current video event as a preferred event. Moreover, the system can monitor if the user keeps returning to the interstitial video content being presented on a particular channel. If so, the implication is that the user is anticipating a return to the desired programming content and, therefore, the system can flag that programming content as a user-preferred event. As yet another example, if the user is watching a video event on a channel that has already been marked or designated as a “favorite” of the user, then the system can automatically designate that video event as a user-preferred event for purposes of the RtC features.

The process monitors the first video event to detect interstitial video content, e.g., a commercial break. The detection of interstitial content may be performed by a backend system component, by the video services receiver, and/or by the presentation device. The process 300 could leverage any appropriate technique to determine that a commercial break has begun or is in progress. For example, the process 300 could analyze the video data for the first video event to detect the transition from a segment of program content to a segment of interstitial video content. In this regard, the process 300 may consider metadata in the video data (such as flags, tags, or markers), closed captioning data, audio data, video frame information, pixel luminance data, or the like. In certain embodiments, the process 300 may receive information, signaling data, and/or metadata from one or more third party services, wherein the received information indicates or otherwise corresponds to transitions between program content and interstitial content. For example, if the first video event is a live broadcast of a sporting event, then game or player statistics could be analyzed to detect breaks or downtime in the sporting event (which usually corresponds to commercial breaks). The statistics monitoring service provided by STATS LLC is one example of a suitable third party application that could be leveraged by the process 300.

This example assumes that the process 300 detects a commercial break, and that the first video event has transitioned from a previous segment of program content to a current segment of interstitial video content. The process 300 continues by monitoring for a channel switching action that occurs in association with the presentation of the interstitial video content (query task 306). This description assumes that the process 300 checks for a channel change during the commercial break. In other scenarios, the process 300 might check for a channel change event that occurs at or near the beginning of the commercial break. For example, if the viewer switches channels within a designated time period before a commercial break, then the process 300 may still proceed as described below. In other words, the process 300 may be suitably configured to react to channel switching at any time, or at times that satisfy certain criteria.

Referring again to FIG. 4, the timeline includes a time 410 during the segment of interstitial video content 406. At this time 410, the video presentation system is operated to switch from Channel 8 to Channel 2. This channel change action results in the presentation of a second video event 412 on a second video service corresponding to Channel 2. The program content on Channel 2 is identified by the letter “B” in FIG. 4. Consequently, after the time 410, the second video event 412 is presented to the user in place of the interstitial video content 406 on Channel 8.

Referring back to FIG. 3, if the channel is not changed (the “No” branch of query task 306), then the process 300 may exit or return to task 302, as shown. This description assumes that the process 300 detects a channel switching action that occurs during presentation of the interstitial video content (the “Yes” branch of query task 306). In response to the channel change, the process 300 provides a second video event on a second video service for presentation to the user (task 308). Notably, the second video event is displayed on the same presentation device, instead of the first video event. Nonetheless, the video stream data for the first video event is monitored and analyzed in the background. In this context, a video services receiver having multiple tuners can be utilized to process one video stream in the background while concurrently processing and rendering another video stream as the currently displayed stream.

The process 300 continues to monitor the first video event, related metadata, and/or independently received information to determine whether or not the current commercial break (of the first video event) has ended (query task 310). Any of the detection techniques and monitoring methodologies described above with reference to query task 304 may also be used here to detect the end of the commercial break. Notably, this background monitoring function can be performed during presentation of the second video event and during presentation of any other video event that may be presented after the initial channel switching action has been executed. In other words, the process 300 continues to monitor for the end of the commercial break in the first video event, regardless of how many times the channel is changed. This enables the process 300 to remain effective during “channel surfing” activities that often occur during commercial breaks. Although not depicted in FIG. 3, the process 300 may exit if it detects that the presentation device has returned to Channel 8 (the first video event).

This example assumes that the process 300 successfully detects that the commercial break has ended (the “Yes” branch of query task 310). In certain embodiments, the process 300 detects a transition from the interstitial video content to the next program segment of the first video event. Again, the end of the commercial break can be detected in the background during the presentation of the second video event on the presentation device. Referring to FIG. 4, the time 414 corresponds to the transition from the interstitial video content 406 to the program segment 408.

In response to the detection of the transition, the process 300 continues by automatically (with little to no user involvement) switching from the second video service back to the first video service (task 312). This action causes the preferred video event to resume. The time 414 (see FIG. 4) also represents the channel switching transition, where the video presentation system automatically switches from Channel 2 to Channel 8 to resume presentation of the program segment 408. In certain embodiments, task 312 is performed automatically and seamlessly without user action, which allows the user to immediately resume watching the first video event as soon as the commercial break ends.

FIG. 5 is a diagram that illustrates a notification feature associated with an automatic RtC operation. FIG. 5 shows the time 410 corresponding to a channel switching action that causes the system to change from Channel 8 to Channel 2. In contrast to the automatic RtC function described above, the methodology depicted in FIG. 5 initially generates a suitably formatted program return notification 418 at a time 420, and provides or communicates the notification, if needed. The program return notification 418 is intended for the user/viewer who changed the channel. The program return notification 418 indicates that the interstitial video content has ended, will soon end, etc. Thus, the notification 418 serves as a reminder that the actual program content of the first video event has resumed, and that the user can now switch back to the original channel (Channel 8 in this example).

If the user fails to manually return to the first video event after a threshold period of time has passed after presentation of the program return notification 418, then the system automatically switches back to the first video event, as described above. FIG. 5 shows a time 422 that occurs after a short period of time following the program return notification 418. In certain embodiments, the program return notification includes or is realized as an interactive graphical user interface (GUI) element having at least one graphical control that allows the user to interact with the notification for purposes of controlling the video system. As one example, the GUI element may include a control feature that, when activated, initiates switching from the current video service (for the currently viewed channel) back to the first video service. As another example, the GUI element may include a control feature that, when activated, initiates recording of the first video event. This video recording function allows the user to continue viewing the second video event with the confidence that the remainder of the first video event can be viewed at a later time. Similarly, the GUI element may include a control feature that, when activated, pauses the presentation of the first video event. In this regard, if the first video event is a non-recorded event, then the “pause” feature may initiate buffering of the first video event. If, however, the first video event is a recorded event, then the “pause” feature may simply halt the playback of the first video event. In accordance with yet another example, the GUI element may include a control feature that, when activated, initiates presentation of the first video event on a second presentation device. Thus, the program return notification could be configured to allow the user to move or place-shift the first video event to another presentation device, such as a smartphone, a computing device, a smart television, a smart disc player, or the like. See, for example, the system 200 described above with reference to FIG. 2.

The program return notification may include other features and functionality if so desired. For example, the notification may include a GUI control element that allows the user to indicate that he or she is no longer interested in watching the first video event. This type of control could be realized as a simple “ignore” or “clear” button that is graphically represented. As another example, the notification may include a GUI control element that allows the user to request a follow up reminder after the next commercial break, in five minutes, or the like. In certain embodiments, the program return notification can be a simple icon, indicator light, or audible signal that is intended to serve as a quick reminder for the user.

Although FIG. 3 depicts only one iteration of the process 300, it should be appreciated that the process 300 can be repeated in an ongoing manner as needed for purposes of detecting any or all commercial breaks in a video event. Moreover, multiple instantiations of the process 300 could be executed in a concurrent manner (assuming that the presentation device or the video services receiver has sufficient resources and processing capacity). Multiple instantiations of the process 300 may be desirable to monitor commercial breaks in a plurality of different video events that may be of interest to the user.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of managing delivery of video content, the method comprising:
determining, with a video presentation system, that a first video event currently provided on a first video service is preferred by a user of the video presentation system;
detecting a channel switching action that occurs in association with presentation of interstitial video content corresponding to the first video event on the first video service;
providing a second video event on a second video service for presentation to the user, wherein the providing is performed after detecting the channel switching action;
detecting, with the video presentation system, completion of the interstitial video content on the first video service;
generating and presenting a program return notification that indicates completion of the interstitial video content, the program return notification intended for presentation to the user, and the program return notification comprising a graphical user interface control element that, when activated, initiates presentation of the first video event on a second presentation device that is different than the video presentation system; and
when the user fails to manually return to the first video event after a threshold period of time has passed after presentation of the program return notification, automatically switching from the second video service to the first video service to resume presentation of the first video event to the user.

2. The method of claim 1, wherein the interstitial video content comprises a commercial break between two program segments of the first video event.

3. The method of claim 1, wherein detecting completion of the interstitial video content comprises:
detecting a transition from the interstitial video content to a program segment of the first video event.

4. The method of claim 1, wherein the determining step comprises:
monitoring a continuous viewing time period during which the first video event is presented by the video presentation system; and
designating the first video event as a preferred video event when the continuous viewing time period exceeds a threshold time period.

5. The method of claim 1, wherein the determining step comprises:
receiving, at the video presentation system, a user-initiated command to designate the first video event as a preferred video event.

6. The method of claim 5, wherein the user-initiated command is received during presentation of a program segment of the first video event on the first video service.

7. The method of claim 5, wherein the user-initiated command is received during presentation of the interstitial video content on the first video service.

8. The method of claim 5, wherein the user-initiated command is generated in response to user activation of a “Back to Program” button of a remote control device that wirelessly controls operation of the video presentation system.

9. (canceled)

10. A video presentation system comprising:
a receiver interface to receive data associated with video services, including a first video event on a first video service and a second video event on a second video service;
a display interface for a display operatively coupled to the video services receiver, the display interface facilitating presentation of video content on the display; and
a processor coupled to the receiver interface and the display interface, wherein the processor designates the first video event on the first video service as a user-preferred video event, detects a channel switching action that occurs in association with presentation of interstitial video content corresponding to the first video event, provides the second video event for presentation to a user in response to detecting the channel switching action, detects completion of the interstitial video content on the first video service, generates and presents a program return notification that indicates completion of the interstitial video content, the program return notification intended for presentation to the user, and the program return notification comprising a graphical user interface control element that, when activated, initiates presentation of the first video event on a second presentation device that is different than the video presentation system, and automatically switches from the second video service to the first video service content when the user fails to manually return to the first video event after a threshold period of time has passed after presentation of the program return notification, such that presentation of the first video event to the user is resumed.

11. The video presentation system of claim 10, wherein the receiver interface and the display interface reside at a video services receiver.

12. The video presentation system of claim 10, wherein the receiver interface and the display interface reside at a mobile device.

13. The video presentation system of claim 10, wherein the processor detects completion of the interstitial video content by detecting a transition from the interstitial video content to a program segment of the first video event.

14. The video presentation system of claim 10, wherein the video presentation system monitors a continuous viewing time period during which the first video event is presented by the video presentation system, and the processor designates the first video event as a user-preferred video event when the continuous viewing time period exceeds a threshold time period.

15. The video presentation system of claim 10, wherein the video presentation system receives, a user-initiated command to designate the first video event as a user-preferred video event.

16-19. (canceled)
